(19) United States
(12) Patent Application Publication
(10) Pub. No.: US 2024/0071643 A1
(43) Pub. Date: Feb. 29, 2024

(54) RADIATION-TO-GENERATOR SYSTEM FOR SPACE APPLICATIONS

(71) Applicant: Hamilton Sundstrand Space Systems International, Inc., Windsor Locks, CT (US)

(72) Inventor: Yehia F. Khalil, Glastonbury, CT (US)

(21) Appl. No.: 17/895,201

(22) Filed: Aug. 25, 2022

(51) Int. Cl. G21H 1/02; G21H 1/06

(52) U.S. Cl. CPC G21H 1/02; G21H 1/06

(57) ABSTRACT

A radiation-to-generator (RTG) system includes an externally shielded cylindrical betavoltaic battery having sidewalls extending between an upper surface and a bottom surface. An external power electronic system is connected to the betavoltaic battery to receive power. The betavoltaic battery is configured to convert energy produced from radioisotope beta-decay to electricity that is configured to power the external power electronic system.

### BACKGROUND

The present disclosure is generally related to power generation systems, and more specifically, to a radiation-to-generator system for space applications.

Advances in aerospace technologies have facilitated an increase in orbiting distances from Earth and long durations of deep space missions (e.g., missions to the Moon, Mars, and beyond). Long-missions of crewed and uncrewed space vehicles in deep space exploration as well as low earth orbit (LEO) missions require reliable supply of electricity and long service life (e.g., in the range of a few months to a few years) to power the remote electronic components. Also, heating the electronic devices in the deep space (at or below minus 245° F.) is a necessity.

Radiation belts such as the Van-Allen belts can destroy the solar photovoltaic (solar PV) panels typically used for electricity generation in space vehicles by harvesting sun radiation. Also, solar PV would not function in space darkness far from the sun.

### BRIEF SUMMARY

According to a non-limiting embodiment, a radiation-to-generator (RTG) system comprises a betavoltaic (BV) battery having cylindrical sidewalls extending between an upper surface and a bottom surface. An external power electronic system is connected to the betavoltaic battery to receive power. The betavoltaic battery is configured to convert energy produced from radioisotope beta-decay to electricity that is configured to power the external power electronic system.

In addition to one or more aspects of the system disclosed herein or as an alternate, the system (e.g., betavoltaic battery) comprises a beta-particles source extending along a center axis from a first end to an opposing second end; a semiconductor device including a first-type extrinsic semiconductor surrounding the beta-particles source, and a second-type extrinsic semiconductor surrounding the first-type extrinsic semiconductor and the beta-particles source; and a radioactive shield housing surrounding the second-type extrinsic semiconductor, the first-type extrinsic semiconductor, and the beta-particles source.

In addition to one or more aspects of the system disclosed herein or as an alternate, the radioactive shield housing includes cylindrical sidewalls extending between an upper surface and a bottom surface, the upper and bottom surfaces extending radially about a center axis to define a cylindrica configuration of the betavoltaic battery.

In addition to one or more aspects of the system disclosed herein or as an alternate, the first-type extrinsic semiconductor is a p-type semiconductor and the second-type extrinsic semiconductor is an n-type semiconductor.

In addition to one or more aspects of the system disclosed herein or as an alternate, the first-type extrinsic semiconductor separated from the beta-particles source to define an annular gap therebetween.

In addition to one or more aspects of the system disclosed herein or as an alternate, the second-type extrinsic semiconductor is coupled to the first-type extrinsic semiconductor to define a p-n junction.

In addition to one or more aspects of the system disclosed herein or as an alternate, the first-type extrinsic semiconductor and the second-type extrinsic semiconductor each include a porous structure to receive electron collisions.

In addition to one or more aspects of the system disclosed herein or as an alternate, the first-type extrinsic semiconductor and the second-type extrinsic semiconductor are each doped with impurity atoms.

In addition to one or more aspects of the system disclosed herein or as an alternate, the radioactive shield housing includes a thin layer of high-density polyethylene (HDPE) deposited on an outer surface thereof.

In addition to one or more aspects of the system disclosed herein or as an alternate, the betavoltaic battery further comprising a first electrode that is electrically connected to the first-type extrinsic semiconductor and an input of the external power electronic system, and a second electrode that is electrically connected to the second-type extrinsic semiconductor and an output of the external power electronic system.

In addition to one or more aspects of the system disclosed herein or as an alternate, the beta-particles source includes a beta emitter nuclear isotope characterized by a long half-life to provide long service life of the battery suitable for space applications.

In addition to one or more aspects of the system disclosed herein or as an alternate, the beta emitter nuclear isotope produces electrons in response to realizing radioisotope beta-decay, and wherein the betavoltaic battery converts kinetic energy of the electrons to the electricity.

In addition to one or more aspects of the system disclosed herein or as an alternate, the power electronic system comprises a data communication system.

According to another non-limiting embodiment, a betavoltaic battery comprises a beta-particles source, a semiconductor device, and a radioactive shield housing. The betavoltaic battery extends along a center axis from a first end to an opposing second end. The semiconductor device includes a first-type extrinsic semiconductor surrounding the beta-particles source, and a second-type extrinsic semiconductor surrounding the first-type extrinsic semiconductor and the beta-particles source. The radioactive shield housing surrounds the second-type extrinsic semiconductor, the first-type extrinsic semiconductor, and the beta emitter nuclear isotope. The radioactive shield housing includes cylindrical sidewalls extending between an upper surface and a bottom surface. The upper and bottom surfaces extends radially about a center axis to define a profile of the betavoltaic battery.

In addition to one or more aspects of the system disclosed herein or as an alternate, the radioactive shield housing includes cylindrical sidewalls extending between an upper surface and a bottom surface.

In addition to one or more aspects of the system disclosed herein or as an alternate, the first-type extrinsic semiconductor is a p-type semiconductor and the second-type extrinsic semiconductor is an n-type semiconductor.

In addition to one or more aspects of the system disclosed herein or as an alternate, the first-type extrinsic semiconductor separated from the beta-particles source to define an annular gap therebetween.

In addition to one or more aspects of the system disclosed herein or as an alternate, the second-type extrinsic semiconductor is coupled to the first-type extrinsic semiconductor to define a p-n junction.

In addition to one or more aspects of the system disclosed herein or as an alternate, the first-type extrinsic semiconductor and the second-type extrinsic semiconductor each include a porous structure to receive electron collisions.

In addition to one or more aspects of the system disclosed herein or as an alternate, the first-type extrinsic semiconductor and the second-type extrinsic semiconductor are each doped with impurity atoms.

### BRIEF DESCRIPTION OF THE DRAWINGS

The following descriptions should not be considered limiting in any way. With reference to the accompanying drawings, like elements are numbered alike:

FIG. 1 depicts a radiation-to-generator system according to a non-limiting embodiment of the present disclosure;

FIG. 2 is top cross-sectional view of a betavoltaic battery shown in FIG. 1 taken along line A-A;

FIG. 3 is a cross-sectional view of the betavoltaic battery shown in FIG. 1 taken along line X-X; and

FIG. 4 is a cross-sectional view of the betavoltaic battery shown in FIG. 3 taken along line B-B.

### DETAILED DESCRIPTION

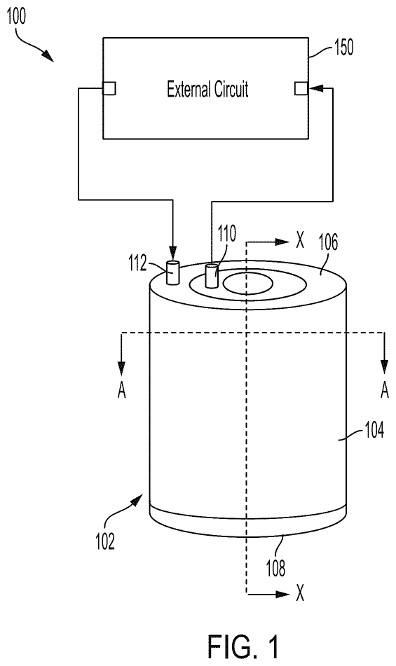

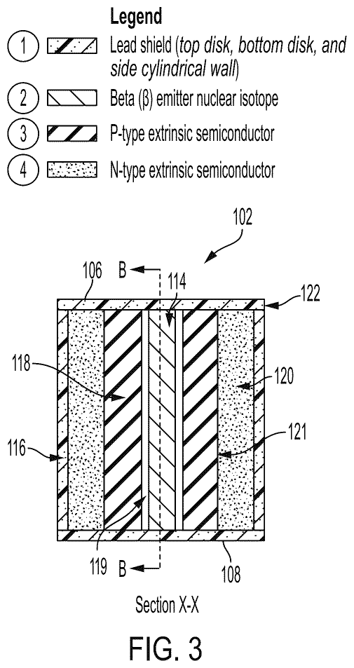

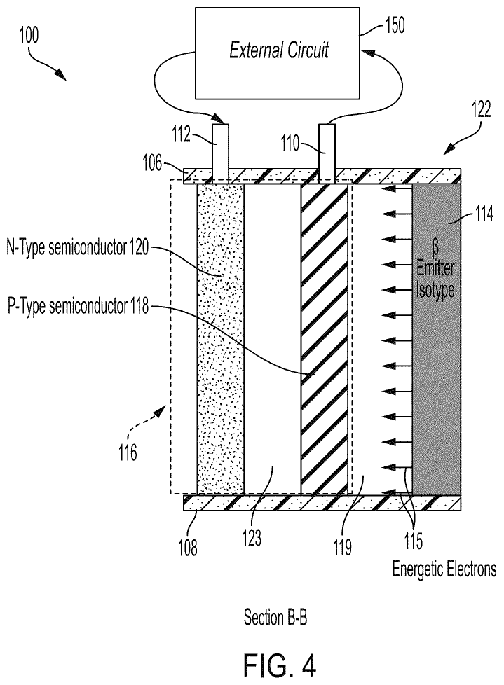

A detailed description of one or more embodiments of the disclosed apparatus and method are presented herein by way of exemplification and not limitation with reference to the FIGS. 1 through 4).

Various non-limiting embodiments described herein provide a betavoltaic (BV) battery configured to convert energy produced from radioisotope beta-decay to electricity configured to power an external power electronic system. The betavoltaic battery is capable of generating electricity and heat to support LEO as well as deep space applications. In one or more non-limiting embodiments, the heat generated by the betavoltaic battery (BV) can be produced by emitted high-energy electrons as they collide with the lattice of the semiconductor material that surrounds the beta-particles emitter. The emitted electrons dissipate their kinetic energy, in the form of thermal energy, into the semiconductor causing its temperature to rise. The heat generated from the BV device can be used to heat, via conductive and radiative heat transfer, the power electronic board or device attached to or in the vicinity to the BV battery. In one or more non-limiting embodiments, the BV battery includes a wide-bandgap (WBG), porous solid-state semiconductor that is protected by a radiation-resistant housing e.g. a radiation shield), which allows the BV battery to outperform solar power cells due to their inability to function when spacecraft orbits pass through radiation belts (such as the Van Allen belts) and during long periods of darkness.

In one or more non-limiting embodiments, energetic beta particles emitted from the decay of radioactive isotopes impinge on the semiconductor device to generate electron-hole pairs by impact ionization. The impingement of one beta particle can create multiple electron-hole pairs through a series of interaction. The electron-hole pairs diffuse to the depletion region of the p-n junction or Schottky junction defined by the semiconductor device, and are separated to form free holes and electrons by the built-in electric field. The charges drift in the semiconductor layer and holes and electrons are collected at the anode and cathode electrodes, respectively. Hence, the electrons kinetic energy of the emitted beta particles is converted to electrical energy, which can be used to power the connected various electronic circuit boards and/or devices included in the external power electronic system.

With reference to FIG. 1, a radiation-to-generator (RTG) system 100 is illustrated according to a non-limiting embodiment of the present disclosure. The RTG system 100 includes a betavoltaic battery 102 and an external power electronic system 150 configured to receive power from the betavoltaic battery 102. In one or more non-limiting embodiments, the BV battery 102 is configured to convert energy produced from radioisotope beta-decay to electricity configured to power the power electronic system 150.

The betavoltaic (BV) battery 102 includes cylindrical sidewalls 104 extending between an upper surface 106 and a bottom surface 108. According to one or more non-limiting embodiments, the upper and bottom surfaces 106 and 108 extend radially about a center axis (X-X) to define a cylindrical profile having circular or tubular sidewalls.

The power electronic system 150 is electrically connected to the betavoltaic battery 102 to receive generated electrical power. The power electronic system 150 can include various types of systems including, but not limited to remote sensors, printed circuit boards (PCB), micro-electromechanical systems (MEMS), micro-actuators, etc.

In one or more non-limiting embodiments, the betavoltaic battery 102 includes a first electrode 110 and a second electrode 112. A first end of the first and second electrodes 110 can be connected to a semiconductor device utilized by the betavoltaic battery 102 to produce the converted electricity. A second end of the first electrode 110 can be connected to an input 152 of the power electronic system 150, while a second end of the second electrode 112 is electrically connected to an output 154 of the power electronic system 150. In this manner, the converted electricity output from the betavoltaic battery 102 can power the power electronic system 150.

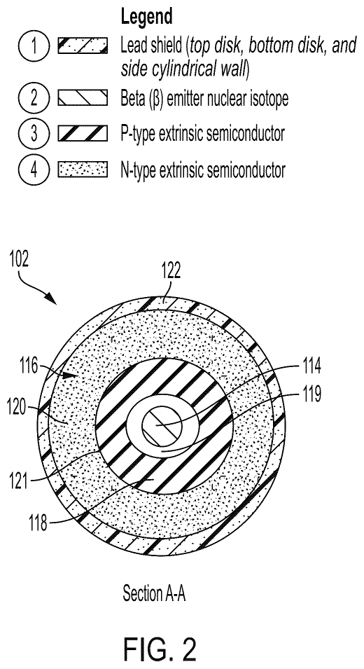

Turning now to FIGS. 2, 3 and 4, various cross-sectional views depict the betavoltaic battery 102 included in the RTG system 100 according to one or more non-limiting embodiments. The betavoltaic battery 102 includes a beta-particles source 114, a semiconductor device 116, and a radioactive shield housing 122.

The beta-particles source 114 extends along a center axis (B-B) from an upper end disposed adjacent the upper surface 106 to an opposing second end disposed adjacent the lower surface 108. In one or more non-limiting embodiments, the beta-particles source 114 includes a beta-emitter nuclear isotope that produces high-energy electrons in response to realizing radioisotope beta-decay. Various types of beta emitter nuclear isotopes can used to implement the beta-particles source 114 including, but not limited to, Tritium (³T₁), Nickel (⁶³Ni₂₈), Krypton (⁸⁵Kr₃₆), Strontium (⁹⁰Sr₃₈), and Ruthenium (¹⁰⁶Ru₄₄). Table 1 below lists various characteristics of beta-decay radioactive isotopes with long service lives suitable for space applications, along with their respective half-lives ranging from 1 year up to about 100 years.

TABLE 1

| | | Maximum Energy | Average Energy | Specific | Specific |
|---|---|---|---|---|---|
| Name of Radioactive | Half- | of Emitted Beta | of Emitted Beta | Power of | Activity of |
| Isotope | Life | Particles | Particles | Isotope | Isotope |
| (Only Beta Decay) | (year) | (KeV) | (KeV) | (W/gram) | (Curie/gram) |
| Tritium (³T₁) | 12.32 | 18.60 | 5.68 | 9678.90 | 0.326 |
| Nickel (⁶³Ni₂₈) | 101.20 | 65.87 | 17.13 | 56.11 | 0.006 |
| Krypton (⁸⁵Kr₃₆) | 10.75 | 687.00 | 250.51 | 391.43 | 0.110 |
| Strontium (⁹⁰Sr₃₈) | 28.90 | 546.00 | 195.80 | 137.54 | 0.160 |
| Ruthenium (¹⁰⁶Ru₄₄) | 1.02 | 39.40 | 10.03 | 3313.11 | 0.197 |

The semiconductor device 116 includes a first-type extrinsic semiconductor 118 and a second-type semiconductor 120. The first-type extrinsic semiconductor 118 surrounds the beta-particles source 114. In one or more non-limiting embodiments, the first-type extrinsic semiconductor 118 is separated from the beta-particles source 114 to define an annular gap 119 therebetween. The second-type extrinsic semiconductor 120 surrounds the first-type extrinsic semiconductor 118 and the beta-particles source 114. Accordingly, energetic beta particles 115 emitted from the decay of radioactive isotopes from the beta-particles source 114 impinge on the semiconductor device 116 and generate electron-hole pairs by impact ionization to create multiple electron-hole pairs through a series of interaction. Accordingly, the electron-hole pairs diffuse to the depletion region of the p-n junction 121 such that the of the semiconductor device 116 can convert energy produced from radioisotope beta-decay to electricity.

When the n-type semiconductor 120 is coupled with p-type semiconductor 118, the free electrons from n-type semiconductor 120 move or “jump” to fill the holes in the p-type semiconductor 118. As a result, a depletion region 123 is formed in the p-n junction 121, e.g. between the n-type semiconductor 120 and the p-type semiconductor 118. In other words, the p-n junction 121 becomes a depletion zone 123 due to the movement of the electrons and formation of holes. In the depletion region 123, the layer where electrons leave now has a positive charge and the layer where electrons migrate now have negative charge.

The first-type and second-type semiconductors 118 and 120 each operate according to a lower energy level of a semiconductor referred to as the valence band (EV) and an higher energy level at which an electron can be considered free is called the conduction band (EC). The excitation of an electron to the conduction band leaves behind an empty space for an electron. An electron from a neighboring atom in the crystal lattice can move into this empty space. When this electron moves, it leaves behind another space (e.g., a hole). The continual movement of the space for an electron, called a ‘hole’, is effected by the movement of a positively charged particle through the crystal lattice structure of the semiconductor material. Consequently, the excitation of an electron into the conduction band results in not only an electron (e−) in the conduction band but also a hole (h+) in the valence band. The hole signifies absence of an electron (e−) in the semiconductor crystal lattice. Thus, both the electron (e−) and hole (h+) can participate in conduction and are called “carriers.”

In one or more non-limiting embodiments, the p-type semiconductor 118 and/or the n-type semiconductor 120 can be doped with additional impurity atoms (typically referred to as “dopants”) to increase the number of free electrons and holes in order to increase the battery's conversion efficiency. For example, the p-type semiconductor 118 (e.g., GaN, SiC, etc.) can be doped with three (3) valance-electrons atom such as Boron (B), Aluminum (Al), Gallium (Ga), and Indium (In), and the n-type semiconductor 120 (GaN or N-type SiC) can be doped with five (5) valence-electrons atom such as Phosphorus (P), Arsenic (As), and Antimony (Sb). The p-type semiconductor 118 may be referred to as having “free holes” (h+), while the n-type semiconductor 120 may be referred to as having “extra free electrons.”

In one or more non-limiting embodiments, the first-type extrinsic semiconductor 118 is a p-type semiconductor and the second-type extrinsic semiconductor 120 is an n-type semiconductor. Accordingly, the p-type semiconductor 118 and n-type semiconductor 120 can be coupled together to define a p-n junction 121.

Various wide bandgap (WBG) semiconductors can be used to implement the p-type semiconductor 118 and n-type semiconductor 120. Materials used to implement the p-type semiconductor 118 and n-type semiconductor 120 include, but are not limited to, silicon carbide (SiC), gallium nitride (GaN) and zinc oxide (ZnO). Table 2 below compares a baseline bandgap energy of silicon (Si) versus the various examples of WBG materials that can be utilized in the betavoltaic battery 102 to increase the conversion efficiency of the betavoltaic battery 102.

TABLE 2

| | | Wide bandgap (WBG) | | |
|---|---|---|---|---|
| | Silicon (Si) | Semiconductors | | |
| | Baseline | Silicon | Gallium | Zinc |
| | Intrinsic | Carbide | Nitride | Oxide |
| Semiconductor | Semiconductor | (SiC) | (GaN) | (ZnO) |
| Bandgap (BG) in eV | 1.12 | 3.26 | 3.39 | 3.37 |
| Density (grams/cm³) | 2.33 | 3.22 | 6.16 | 5.60 |

A baseline BG as described herein refers to the energy required for electrons and holes to transition from the valence band to the conduction band. Silicon (Si), for example, has a band gap of 1.12 eV (electron volt), and is utilized herein as baseline reference value. The BG energy is the minimum amount of energy required for an electron to break free of its bound state and when this BG energy is met, the electron is excited into a free state and, hence, can participate in conduction. A hole is created where the electron was formerly bound, and this hole also participates in conduction.

A semiconductor with a wide BG value is referred to herein as a WBG semiconductor. Empirically, the average energy of one electron-hole pairs generation is equal to 2.8Eg+0.5 eV. That relationship indicates that the energy conversion efficiency increases with the bandgap. Accordingly, the wide bandgap semiconductors (examples are provided in Table 2) offer large conversion efficiency from the kinetic energy of the emitted electrons to electricity. A doped n-type semiconductor material is an extrinsic semiconductor that has been doped so that the majority carriers are electrons. A doped p-type material is an extrinsic semiconductor that has been doped so that the majority carriers are holes. When electrons cross from the n-type material to the p-type material, they leave positive charge and when the holes move to the n-type material, they leave a layer of negative charges.

In one or more non-limiting embodiments, the p-type and n-type extrinsic semiconductors 118 and 120 include a porous structure (e.g., a porous solid-state semiconductor material) to maximize the surface area exposed to collisions by the energetic electrons (namely, the β-particles) emitted from the radioactive source 114. Accordingly, the p-type and n-type extrinsic semiconductors 118 and 120 can increase the effective surface area of the semiconductor device 116 and, thus, improving isotope source conversion efficiency of the betavoltaic battery 102 to provide a higher power density.

The radioactive shield housing 122 surrounds the second-type extrinsic semiconductor 118, the first-type extrinsic semiconductor 118, and the beta-particles source 114. The radioactive shield housing defines the sidewalls 104, the upper surface 106 and the lower surface 108 of the betavoltaic battery 102. The radioactive shield housing 122 includes a radiation-resistant material including, but not limited to lead (Pb), aluminum (Al), tungsten (W), tantalum (Ta). In one or more non-limiting embodiments, a thin layer of high-density polyethylene (HDPE) is deposited on an outer surface of the radioactive shield housing 122 to protect the radioactive shield housing (e.g., the lead or aluminum, tungsten, or tantalum sheet) from potential mechanical impact damage.

As described herein, one or more non-limiting embodiments provide a RTG system that includes direct conversion betavoltaic (BV) battery capable of generating electricity and heat to support LEO as well as deep space applications. As the emitted electrons from the isotope source collide with the semiconductor materials, thermal energy is deposited in the crystal lattice of the semiconductor which heats the crystal. This thermal energy can be transferred (via conductive and radiative heat transfer modes) to the power electronic circuit powered by the betavoltaic battery. The BV battery includes a wide-bandgap (WBG), porous solid-state semiconductor device that is protected by a radiation-resistant housing, which allows the BV battery to outperform traditional solar photovoltaic cells due to their inability to function when the spacecraft orbits pass through radiation belts and during long periods of darkness.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A radiation-to-generator (RTG) system comprising:
a betavoltaic battery including sidewalls extending between an upper surface and a bottom surface, the upper and bottom surfaces extending radially about a center axis to define a cylindrical profile; and
an external power electronic system connected to the betavoltaic battery,
wherein the betavoltaic battery is configured to convert energy produced from radioisotope beta-decay to electricity that is configured to power the external power electronic system.

2. The RTG system of claim 1, wherein the betavoltaic battery comprises:
a beta-particles source extending along a center axis from a first end to an opposing second end;
a semiconductor device including a first-type extrinsic semiconductor surrounding the beta-particles source, and a second-type extrinsic semiconductor surrounding the first-type extrinsic semiconductor and the beta-particles source; and
a radioactive shield housing surrounding the second-type extrinsic semiconductor, the first-type extrinsic semiconductor, and the beta-particles source,

3. The RTG system of claim 2, wherein the radioactive shield housing includes sidewalls extending between an upper surface and a bottom surface, the upper and bottom surfaces extending radially about a center axis to define a cylindrica configuration of the betavoltaic battery.

4. The RTG system of claim 2, wherein the first-type extrinsic semiconductor is a p-type semiconductor and the second-type extrinsic semiconductor is an n-type semiconductor.

5. The RTG system of claim 4, wherein the first-type extrinsic semiconductor separated from the beta-particles source to define an annular gap therebetween.

6. The RTG system of claim 5, wherein the second-type extrinsic semiconductor is coupled to the first-type extrinsic semiconductor to define a p-n junction.

7. The RTG system of claim 6, wherein the first-type extrinsic semiconductor and the second-type extrinsic semiconductor each include a porous structure to receive electron collisions.

8. The RTG system of claim 7, wherein the first-type extrinsic semiconductor and the second-type extrinsic semiconductor are each doped with impurity atoms.

9. The RTG system of claim 5, wherein the radioactive shield housing includes a thin layer of high-density polyethylene (HDPE) deposited on an outer surface thereof.

10. The RTG system of claim 2, wherein the betavoltaic battery further comprising a first electrode that is electrically connected to the first-type extrinsic semiconductor and an input of the external power electronic system, and a second electrode that is electrically connected to the second-type extrinsic semiconductor and an output of the external power electronic system.

11. The RTG system of claim 2, wherein the beta-particles source includes a beta emitter nuclear isotope characterized by a long half-life to provide long service life of the battery suitable for space applications.

12. The RTG system of claim 11, wherein the beta emitter nuclear isotope produces electrons in response to realizing radioisotope beta-decay, and wherein the betavoltaic battery converts kinetic energy of the electrons to the electricity.

13. The RTG system of claim 1, wherein the power electronic system comprises a data communication system.

14. A betavoltaic battery comprising:
a beta-particles source extending along a center axis from a first end to an opposing second end;
a semiconductor device including a first-type extrinsic semiconductor surrounding the beta-particles source, and a second-type extrinsic semiconductor surrounding the first-type extrinsic semiconductor and the beta-particles source; and
a radioactive shield housing surrounding the second-type extrinsic semiconductor, the first-type extrinsic semiconductor, and the beta emitter nuclear isotope, the radioactive shield housing including sidewalls extending between an upper surface and a bottom surface, the upper and bottom surfaces extending radially about a center axis to define a profile of the betavoltaic battery.

15. The betavoltaic battery of claim 14, wherein the radioactive shield housing includes circular sidewalls extending between an upper surface and a bottom surface.

16. The betavoltaic battery of claim 14, wherein the first-type extrinsic semiconductor is a p-type semiconductor and the second-type extrinsic semiconductor is an n-type semiconductor.

17. The betavoltaic battery of claim 16, wherein the first-type extrinsic semiconductor separated from the beta-particles source to define an annular gap therebetween.

18. The betavoltaic battery of claim 17, wherein the second-type extrinsic semiconductor is coupled to the first-type extrinsic semiconductor to define a p-n junction.

19. The betavoltaic battery of claim 18, wherein the first-type extrinsic semiconductor and the second-type extrinsic semiconductor each include a porous structure to receive electron collisions.

20. The betavoltaic battery of claim 19, wherein the first-type extrinsic semiconductor and the second-type extrinsic semiconductor are each doped with impurity atoms.
